(19) United States
(12) Patent Application Publication
(10) Pub. No.: US 2011/0142474 A1
(43) Pub. Date: Jun. 16, 2011

(54) IMAGE FORMING APPARATUS AND IMAGE FORMING METHOD

(75) Inventors: Yasunari Miyazaki, Shizuoka-ken (JP); Yukio Futamata, Shizuoka-ken (JP); Norikazu Ochiai, Shizuoka-ken (JP); Yoshiaki Okano, Shizuoka-ken (JP); Setsuo Takada, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/967,265

(22) Filed: Dec. 14, 2010

Related U.S. Application Data
(60) Provisional application No. 61/287,013, filed on Dec. 16, 2009.

(51) Int. Cl. G03G 15/20

(52) U.S. Cl. 399/69

(57) ABSTRACT

According to one embodiment, an image forming apparatus includes an image forming unit configured to form a toner image on a first surface of a medium, a fixing unit configured to have a heating member which heats the first surface of the medium, and a pressurizing member which is pressed in contact with the heating member via the medium to heat a second surface of the medium, and a supply unit configured to supply a used medium to the image forming unit, a control unit configured to, when the used medium is supplied from the supply unit, control a fixing setting temperature of the pressurizing member to a temperature equal to or lower than a temperature for fixing on the unused medium, and control a fixing temperature of the heating member to a temperature equal to or higher than a temperature for fixing on the unused medium.

### CROSS-REFERENCE TO RELATED APPLICATION

This application is based upon and claims the benefit of U.S. Provisional Application No. 61/287,013, filed on Dec. 16, 2009; the entire contents of which are incorporated herein by reference.

### FIELD

Embodiments described herein relate generally to an image forming apparatus and an image forming method.

### BACKGROUND

A conventional four-drum tandem image forming apparatus operates according to the following procedures. The image forming apparatus forms a toner image on the surface of each of Y, M, C and BK photoconductive members and transfers the toner images on these photoconductive members to an intermediate transfer member. The intermediate transfer member transfers the toner images to a medium. The medium to which the toner images are transferred passes through a fixing device. The fixing device heats both sides of the medium while pressurizing the medium and thus fixes the toner images to the medium. The medium, after passing through the fixing device, is discharged to a paper discharge tray.

Meanwhile, in the conventional fixing device, even when the backside of a printed paper is reused as a medium (hereinafter referred to as a used medium or a used paper with a blank side), temperature control similar to temperature control for a medium that is not a used paper with a blank paper (hereinafter referred to as a unused medium) is carried out. However, each toner to be used has a different melting point. Therefore, when a medium printed by an image forming apparatus using toners of different melting points is used as a used paper with a blank side, the toner on the backside of the medium may remelt because of the difference in melting point and the medium may become stained.

### BRIEF DESCRIPTION OF THE DRAWINGS

FIG. 1 shows an overall configuration of an exemplary image forming apparatus according to an embodiment.

FIG. 2 shows an overall configuration of an exemplary fixing device according to an embodiment.

FIG. 3 illustrates zones defined by the temperature of a heating member and the temperature of a pressurizing member of an exemplary fixing device according to an embodiment.

FIG. 4 illustrates exemplary temperature control of the fixing device at the time of using a used paper with a blank side according to an embodiment.

FIG. 5 is a flowchart showing exemplary procedures for temperature control of the fixing device using a used paper with a blank side according to an embodiment.

### DETAILED DESCRIPTION

In general, according to one embodiment, an image forming apparatus includes: an image forming unit configured to form a toner image on a first surface of a medium; a fixing unit configured to have a heating member which heats the first surface of the medium, and a pressurizing member which is pressed in contact with the heating member via the medium to heat a second surface of the medium; and a supply unit configured to supply a used medium to the image forming unit, a control unit configured to, when the used medium is supplied from the supply unit, control a fixing setting temperature of the pressurizing member to a temperature equal to or lower than a temperature for fixing on the unused medium, and control a fixing temperature of the heating member to a temperature equal to or higher than a temperature for fixing on the unused medium.

### First Embodiment

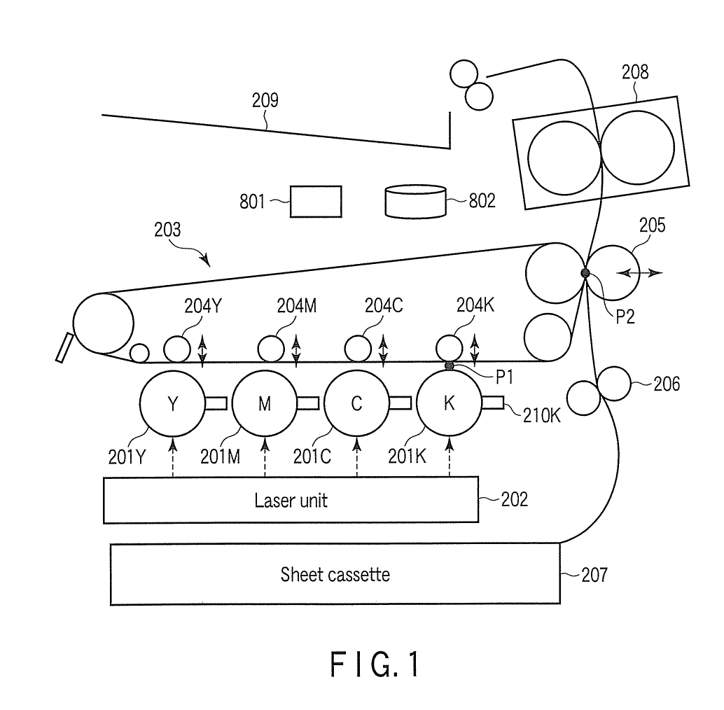

FIG. 1 shows an overall configuration of an exemplary image forming apparatus according to an embodiment. The image forming apparatus shown in FIG. 1 is an electrographic recording apparatus using a four-drum tandem system.

The image forming apparatus has photoconductive members 201Y to 201K, a laser unit 202, a transfer belt 203, primary transfer rollers 204Y to 204K, a secondary transfer roller 205, a registration roller 206, a sheet cassette 207, a fixing device 208, a paper discharge tray 209, a CPU 801, and a memory 802.

The CPU 801 centrally controls various kinds of processing in the image forming apparatus. The CPU 801 also executes programs stored in the memory 802 and thus realizes various functions of the image forming apparatus. The memory 802 includes, for example, a ROM or RAM, and stores various kinds of information used in the image forming apparatus as well as programs.

Next, image formation in the image forming apparatus will be described. The operation will be described using the photoconductive member 201K. However, this operation is similarly applied to the other photoconductive members 201Y to 201C.

When image formation is started, the photoconductive surface of the photoconductive member 201K is cleaned as the photoconductive member 201K rotates. Next, after the photoconductive surface of the photoconductive member 201K is electrically neutralized, charging is carried out. Subsequently, on the basis of image data, the laser unit 202 carries out light exposure to an area where charging is carried out on the photoconductive surface of the photoconductive member 201K and thus forms an electrostatic latent image on the photoconductive surface. The electrostatic latent image is developed with a two-component developer containing a toner and a carrier.

The transfer belt 203 contacts or moves away from the photoconductive member 201K as the primary transfer roller 204K moves. The toner image developed on the photoconductive member 201K is transferred from the photoconductive surface to the belt surface at a predetermined transfer position P1 when the transfer belt 203 contacts the photoconductive member 201K. Similarly, the toner image of each color is transferred onto the transfer belt 203.

The secondary transfer roller 205 is arranged in such a way that the secondary transfer roller 205 can contact and move away from the belt surface of the transfer belt 203. A medium carried from the sheet cassette 207 is pressed against the belt surface at a predetermined secondary transfer position P2 by the secondary transfer roller 205 and the toner image is transferred to the medium.

The fixing device 208 heats and fixes the toner image transferred to the medium. The medium is then discharged to the paper discharge tray 209.

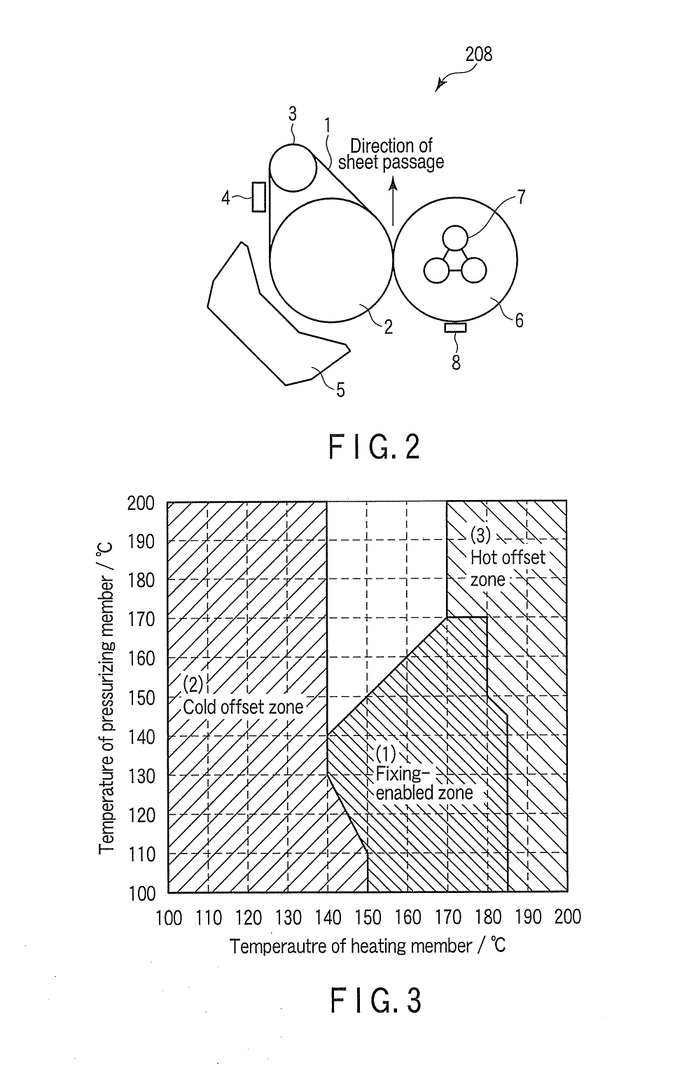

FIG. 2 shows an overall configuration of an exemplary fixing device according an embodiment.

In the fixing device 208, a fixing roller 2 and a pressurizing roller 6 are provided for heating and pressing the medium to which the toner is attached, in contact with the rollers. A fixing belt 1 is stretched over the fixing roller 2 and a tension roller 3. The fixing belt 1 forms an endless track as the rollers 2 and 3 rotate. An IH coil unit 5 heats the fixing belt 1 by induction heating (IH). A temperature sensor 4 detects the temperature of the fixing belt 1.

The pressurizing roller 6 is provided facing the fixing roller 2. A heating source 7 such as a lamp is provided inside the pressurizing roller. In FIG. 2, three heating sources 7 are shown. A temperature sensor 8 detects the surface temperature of the pressurizing roller.

In this embodiment, the heating member is the fixing belt 1. In a fixing device according to another embodiment, the fixing belt is not provided and the heating roller has a heating source. In this configuration, the heating roller is the heating member. In the present embodiment, the pressurizing member is the pressurizing roller 6. In a fixing device according to another embodiment, a pressurizing belt, instead of the pressurizing roller, presses the medium in contact. In this configuration, the pressurizing belt is the pressurizing member.

Next, the operation of the fixing device 208 will be described.

The IH coil unit 5 heats the fixing belt 1 by electromagnetic induction heating. The fixing belt 1 is driven by the rotations of the fixing roller 2 and the tension roller 3. The fixing roller 2, with a spring or the like, presses the fixing belt 1 to the pressurizing roller 6. Meanwhile, the pressurizing roller 6, too, is heated by the internal heating sources 7. Therefore, an area called nip where the medium is heated is formed in the area where the fixing belt 1 contacts the pressurizing roller 6. As the medium passes through the nip in the direction of sheet passage, the toner formed on the medium is melted and fixed.

Next, a problem in the case of using a used paper with a blank side will be described in detail.

When print start is designated by the user, the heating member and the pressurizing member of the fixing device 208 reach a predetermined temperature and then print is carried out. Normally, the fixing temperature of the heating member and the pressurizing member is decided according to fixing conditions, process speed, thermal characteristics of toner and the like. In the case of printing on a used paper with a blank side, the toner on the backside of the medium that is already fixed is remelted because of fixing conditions or heat on the pressurizing side. The adhesive power acting between the roller and the toner is greater than the internal cohesive power of the remelted toner. Consequently, a part of the remelted toner comes off and adheres to the surface of the pressurizing roller, thus causing backside stain. Also, the remelted toner adhering to the pressurizing roller 6 shifts to the heating member such as the fixing belt 1 and thus may cause face stain.

FIG. 3 illustrates zones defined by the temperature of a heating member and the temperature of a pressurizing member of an exemplary fixing device according to an embodiment. The horizontal axis in FIG. 3 represents the temperature of the heating member, that is, the temperature of the fixing belt 1. The vertical axis represents the temperature of the pressurizing member, that is, the temperature of the pressurizing roller 6.

An offset phenomenon in the fixing device 208 is a phenomenon that when the toner melts inappropriately, the toner adheres to and remains on each member of the fixing device 208. A (1) fixing-enabled zone in FIG. 3 is a non-offset zone, that is, a zone where the offset phenomenon does not occur. A (2) cold offset zone in FIG. 3 is a zone where the toner does not melt sufficiently because of low temperature. When the fixing device 208 is used in this zone, the toner on the medium surface adheres to the fixing belt 1. A (3) hot offset zone in FIG. 3 is a zone where the toner melts excessively because of excessively high temperature and the elasticity of the toner is lowered, thus giving adhesive power. Consequently, the toner comes off and adheres to the fixing belt 1.

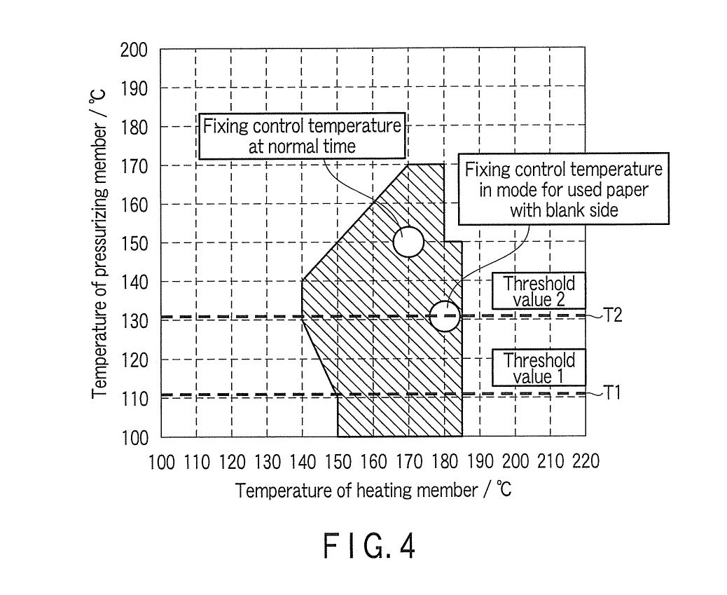

FIG. 4 illustrates exemplary temperature control of the fixing device at the time of using a used paper with a blank side according to an embodiment. Hereinafter, the temperature control of the fixing device will be described with reference to FIG. 4.

When a mode for used paper with a blank side is selected and the start of print is designated, fixing control for the used paper with a blank side is started. Temperature control in a first stage is carried out as follows. The fixing temperature target value of the pressurizing roller 6 is set to a lower value than its fixing temperature target value of normal time. In FIG. 4, the fixing temperature target value of the pressurizing member at normal time is 150° C., whereas the fixing temperature target value of the pressurizing member in the mode for used paper with a blank side is a threshold value 1 (T1) of 110° C. Therefore, the CPU 801 stops power supply to the heating sources 7 of the pressurizing roller 6 until the fixing temperature of the pressurizing member reaches the threshold value 1 (T1), that is, until the temperature sensor 8 to detect the temperature of the surface of the pressurizing roller detects the temperature of the threshold value 1 (T1).

Along with this operation, temperature control is performed by changing the fixing temperature target value of the heating member such as the fixing belt 1 to a temperature equal to or higher than its fixing temperature target value of normal time. In FIG. 4, the fixing temperature target value of the heating member at normal time is 170° C., whereas the fixing temperature target value of the heating member in the mode for used paper with a blank side is 180° C.

Moreover, when an electromagnetic induction heater is used as a unit to heat the heating member, power equivalent to or smaller than the amount of power that is reduced in the heating unit of the pressurizing member is added to power for the electromagnetic induction heater. Also, the upper limit value of output of the electromagnetic induction heater at normal time is raised. This operation enables increase in the quantity of heat supplied to the heating member such as the fixing belt 1. Thus, a sudden temperature fall in the heating member such as the fixing belt 1 due to the deprivation of heat by the pressurizing roller 6 with its temperature lowered is prevented. The image forming apparatus is designed to enter a print waiting state when the temperature of the fixing member is lowered below a predetermined temperature. Therefore, by the above operation, the image forming apparatus can be prevented from entering the waiting state frequently in the mode for used paper with a blank side.

The heating unit to which power equivalent to or smaller than the amount of power reduction is added is not limited to the electromagnetic induction heater. For example, similar control to add power can be performed when inverter control is carried out using a lamp as the heating unit.

The threshold value 1 (T1) needs to be set with reference to the fixing-enabled zone defined by the temperatures of the heating member such as the fixing belt 1 and the pressurizing member such as the pressurizing roller 6. That is, the temperature of the threshold value 1 must be set to such a value that even when the temperature of the pressurizing member is the temperature of the threshold value 1, fixing capability can be secured by controlling the fixing temperature of the heating member such as the fixing belt 1.

As the above temperature control of the first stage is carried out and the temperature of the pressurizing roller 6 falls and reaches the threshold value 1 (T1) during printing, the CPU 801 executes the next temperature control of a second stage. The CPU 801 restores the raised upper limit value of output of the electromagnetic induction heater to the original value, and restores the increased power in the electromagnetic induction heater to the original value. Then, the fixing temperature target value of the heating member such as the fixing belt 1 is restored to the original value. For example, the temperature is restored from 180° C. to 170° C.

In a modification of the embodiment, the fixing temperature target value of the heating member such as the fixing belt 1 is not restored to the original value. That is, in the example shown in FIG. 4, the fixing temperature target value of the heating member in the mode for used paper with a blank side is maintained at 180° C. The purpose of this is to control the fixing temperature of the heating member at a high value in response to the lowered fixing temperature of the pressurizing member.

The CPU 801 then sets the fixing temperature target value of the pressurizing member in the mode for used paper with a blank side to a threshold value 2 (T2) or higher. In FIG. 4, the fixing temperature target value of the pressurizing member in the first stage is 110° C. or lower, whereas the fixing temperature target value of the pressurizing member in the second stage is the threshold value 2 (T2) of 130° C. or higher. Consequently, power supply to the heating sources 7 that heat the pressurizing roller 6 is started.

During printing, the temperature of the pressurizing roller 6 is gradually restored. When the temperature sensor 8 detects that the temperature of the surface of the pressurizing roller now reaches the threshold value 2 (T2), the temperature control of the second stage is ended and the temperature control of the first stage is executed again. In this manner, the temperature controls of the first stage and the second stage are repeated.

Next, the relation that holds between parameters used in the above temperature controls will be described.

The upper limit value of power of the IH coil unit 5 in the mode for used paper with a blank side is P2+P3, where P1 represents the power used by the heating sources 7 as the heating unit on the pressurizing member side, P2 represents the upper limit value of power of the IH coil unit 5 as the heating unit on the heating member side, and P3 represents the quantity of power added to the upper limit value of power of the IH coil unit 5 in the mode for used paper with a blank side. Here, P3 is a smaller value than P1.

This relation can be expressed as follows.

The upper limit value of power of the heating unit on the heating member side in the mode for used paper with a blank side is P2+P3,

where P1 represents the power used by the heating unit on the pressurizing member side, P2 represents the upper limit value of power of the heating unit on the heating member side, and P3 represents the amount of power added to the heating unit on the heating side in the mode for used paper with a blank side.

Here, P1≧P3 holds.

The threshold value 2 (T2) is set at a value that is smaller than the fixing control temperature target value of the pressurizing roller 6 of normal time and greater than the threshold value 1 (T1). Since the threshold value 2 (T2) is the maximum value of the temperature of the pressurizing member in this temperature control, the threshold value 2 (T2) is set at such a value that the toner on the used paper with a blank side does not remelt in the fixing-enabled zone between the heating member such as the fixing belt 1 and the pressurizing roller 6.

The threshold value 1 (T1) needs to be set within the fixing-enabled zone. Moreover, in consideration of the temperature distribution in the longitudinal direction of the pressurizing roller 6 (the direction of the roller axis), it is desirable to set the threshold value 1 (T1) at a higher value (for example, +10° C.) than the lower limit value in the non-offset zone.

Here, the temperatures are in the following relations.

Where Ta1 represents the fixing control temperature target value at normal time (on the heating member side), Tb1 represents the fixing control temperature target value at normal time (on the pressurizing member side), Ta2 represents the fixing control temperature target value in the mode for used paper with a blank side (on the heating member side), Tb2 represents the fixing control temperature target value in the mode for used paper with a blank side (on the pressurizing member side), T1 represents the threshold value 1, and T2 represents the threshold value 2,

the fixing control temperature target value of the heating member in the mode for used paper with a blank side (Ta2) is set equal to or higher than the fixing control temperature target value of the heating member at normal time (Ta1). In this case, the fixing control temperature target value of the pressurizing member in the mode for used paper with a blank side (Tb2) is equal to or lower than the fixing control temperature target value of the pressurizing member at normal time (Tb1). The threshold value 1 (T1) is set equal to or lower than the threshold value 2 (T2).

Moreover, in the first stage of the temperature control, the fixing control temperature target value of the pressurizing member in the mode for used paper with a blank side (Tb2) is set equal to or lower than the threshold value 1 (T1). In the second stage of the temperature control, the fixing control temperature target value of the pressurizing member in the mode for used paper with a blank side (Tb2) is set equal to or higher than the threshold value 2 (T2).

These relations can be expressed by the following formulas.

In the case of Ta1≦Ta2,

first stage: (Tb1≧Tb2) and (T1≧Tb2) and (T1≦T2)

second stage: (Tb1≧Tb2) and (T2≦Tb2) and (T1≦T2).

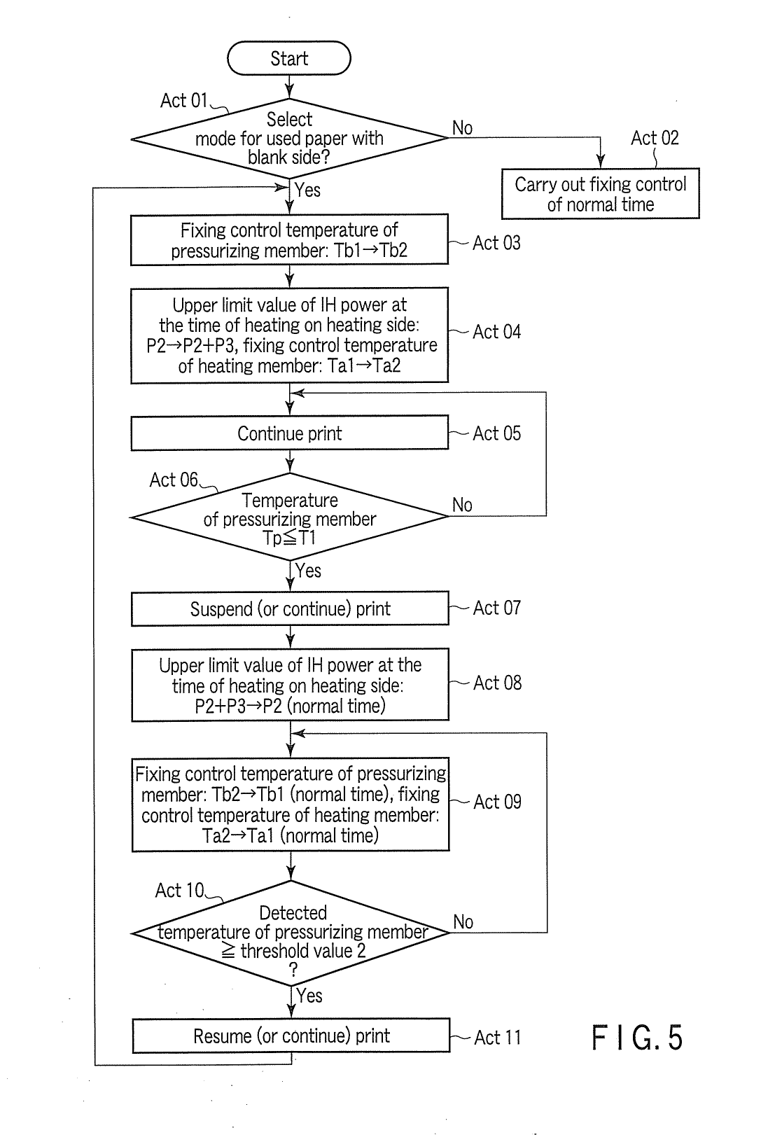

FIG. 5 is a flowchart showing exemplary procedures for the temperature control of the fixing device at the time of using a used paper with a blank side according to an embodiment. In the following description, the same variables as the variables used in the above description will be used and these variables will not be explained further in detail.

When print is started, the CPU 801 in ACT 01 determines whether the print mode is the mode for used paper with a blank side or not. If the print mode is not the mode for used paper with a blank side (No in ACT 01), the CPU 801 starts printing in the normal mode. The printing in the normal mode will not be described in detail here.

If the print mode is the mode for used paper with a blank side (Yes in ACT 01), the CPU 801 changes the fixing control temperature target value of the pressurizing member from Tb1 to Tb2. Here, since Tb1>Tb2 holds, the fixing control temperature target value of the pressurizing member is lower than the current temperature of the heating member. Therefore, the CPU 801 stops power supply to the heating unit of the pressurizing member side.

Although Tb2 represents the fixing control temperature target value (on the pressurizing member side) in the mode for used paper with a blank side, Tb2 can also be handled as a correction value. For example, Tb2 may be used as a correction temperature and the fixing control temperature target value (on the pressurizing member side) in the mode for used paper with a blank side=Tb1−Tb2 may be employed.

In ACT 04, the upper limit value of power of the IH coil unit 5 on the heating side is changed from P2 to P2+P3 by adding P3. Then, the fixing control temperature target value of the heating member is changed from Ta1 to Ta2.

It should be noted that the addition to the upper limit value of heating power of the heating member is made after the fixing control temperature target value of the pressurizing member is changed. Since the limited amount of power should be used, the addition to the upper limit value of power of the IH coil unit 5 is made after the power supply to the pressurizing member side is stopped. If the addition to the upper limit value of power of the IH coil unit 5 on the heating member side is made before the power supply to the pressurizing member is stopped, there is a risk that the maximum power consumption may exceed a prescribed value.

In ACT 05, the image forming apparatus continues the printing. If the temperature sensor 8 detects in ACT 06 that the temperature Tp of the pressurizing member is equal to or lower than T1, which is the temperature of the threshold value 1 (Yes in ACT 06), the upper limit value of power of the IH coil unit 5 on the heating side is restored from P2+P3 to P2 in ACT 08.

In the case where the temperature Tp of the pressurizing member shifts toward T1, which is the temperature of the threshold value 1, when the fixing control temperature exits the fixing-enabled zone, the image forming apparatus suspends the printing in ACT 07. For example, when the temperature of the heating member is lowered and the current fixing temperature is located to the left of the boundary of the fixing-enabled zone in FIG. 4, the printing is suspended.

In ACT 09, the CPU 801 restores the fixing control temperature target value on the pressurizing member side from Tb2 to the target value of normal time Tb1. Thus, the temperature of the pressurizing member rises. The target temperature Tb1 may be any temperature that is higher than the threshold value 2 (T2). The difference between the target temperature Tb1 and the threshold value 2 (T2) is related with the temperature rising speed of the pressurizing member.

The CPU 801 also restores the fixing control temperature target value on the heating member side from Ta2 to the target value of normal time Ta1. As a modification of the embodiment, the fixing control temperature target value on the heating member side may be maintained at Ta2. The reason for this modification is as described above.

If the temperature sensor 8 detects in ACT 10 that the temperature Tp of the pressurizing member is equal to or higher than T2, which is the temperature of the threshold value 2 (Yes in ACT 10), the processing returns to the block of ACT 03 and the above processing is repeated.

In the case where the temperature Tp of the pressurizing member shifts toward T2, which is the temperature of the threshold value 2, when the fixing control temperature is restored to the fixing-enabled zone, the image forming apparatus resumes the printing in ACT 11. For example, when the temperature of the heating member rises and the current fixing temperature is located to the right of the boundary of the fixing-enabled zone in FIG. 4, the printing is resumed.

It should be noted that the fixing control temperature target value on the pressurizing side is restored from Tb2 to Tb1 after the added upper limit value of heating power of the heating member=P2+P3 is returned to the upper limit value=P2. If the fixing control temperature target value on the pressurizing side is restored to the original value before the upper limit value of power of the heating member returns to the normal state, there is a risk that a prescribed value of power consumption may be exceeded by P3, which is the amount of addition to the upper limit value of power.

In the above embodiment, the temperature control target values Tb1 and Tb2 are used in the temperature control of the pressurizing member. However, the temperature may also be controlled by switching on and off the heating sources 7, instead of using target values. Since the temperature control of the pressurizing member is on-off control, the temperature control can be realized by using the heating sources and the temperature sensor, without employing feedback control.

According to the embodiment as described above, when a used paper with a blank side is used, the toner fixed to the printed surface on the backside of the medium can be prevented from remelting, and fixing capability on the face side of the medium can be secured. Thus, face stain and backside stain can be prevented.

The functions described in the embodiment may be configured using hardware or may be realized by causing a computer to read a program that describes the functions using software. These functions may also be configured by properly selecting either software or hardware.

Moreover, the functions can also be realized by causing a computer to read a program that is housed in a recording medium, not shown. Here, the recording medium in the embodiment may have any recording format as long as the recording medium can record the program and can be read by a computer.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit configured to form a toner image on a first surface of a medium;
a fixing unit configured to have a heating member which heats the first surface of the medium, and a pressurizing member which is pressed in contact with the heating member via the medium to heat a second surface of the medium; and
a supply unit configured to supply a used medium to the image forming unit,
a control unit configured to,
when the used medium is supplied from the supply unit,
control a fixing setting temperature of the pressurizing member to a temperature equal to or lower than a temperature for fixing on the unused medium, and
control a fixing temperature of the heating member to a temperature equal to or higher than a temperature for fixing on the unused medium.

2. The apparatus of claim 1, wherein the control unit controls the fixing setting temperature of the pressurizing member to a temperature between a second threshold temperature that is equal to or lower than the temperature for fixing on the unused medium and a first threshold temperature that is lower than the second threshold temperature.

3. The apparatus of claim 2, wherein a fixing temperature expressed by the temperature of the pressurizing member and the temperature of the heating member controlled by the control unit is within a fixing-enabled zone.

4. The apparatus of claim 3, wherein the second threshold temperature is lower than a temperature at which a toner recorded on the second surface of the medium remelts.

5. The apparatus of claim 4, further comprising a first temperature sensor configured to detect the temperature of the pressurizing member,
wherein when the first temperature sensor detects that the temperature of the pressurizing member is equal to or higher than the second threshold temperature, power for heating of the pressurizing member is turned off.

6. The apparatus of claim 5, wherein when the power for heating of the pressurizing member is turned off,
the control unit, after adding power equivalent to or less than the amount of power that is turned off, to an upper limit value of power for heating of the heating member, increases a temperature target value in temperature control of the heating member.

7. The apparatus of claim 6, wherein when the first temperature sensor detects that the temperature of the pressurizing member is equal to or lower than the first threshold temperature,
the control unit, after restoring the temperature target value of the heating member to a value before the increase, restores the upper limit value of power for heating of the heating member to a value before the addition, and turns on the power for heating of the pressurizing member.

8. The apparatus of claim 7, wherein when the fixing temperature expressed by the temperature of the pressurizing member and the temperature of the heating member that are controlled exits the fixing-enabled zone, the control unit stops printing by the image forming apparatus while continuing the temperature control, and when the fixing temperature shifts back into a non-offset zone, the control unit resumes the printing by the image forming apparatus.

9. The apparatus of claim 8, wherein a heating unit which heats the heating member is an induction heater.

10. The apparatus of claim 6, wherein when the first temperature sensor detects that the temperature of the pressurizing member is equal to or lower than the first threshold temperature,
the control unit, after restoring the upper limit value of power for heating of the heating member to a value before the addition, turns on the power for heating of the pressurizing member.

11. The apparatus of claim 10, wherein when the fixing temperature expressed by the temperature of the pressurizing member and the temperature of the heating member that are controlled exits the fixing-enabled zone, the control unit stops printing by the image forming apparatus while continuing the temperature control, and when the fixing temperature shifts back into a non-offset zone, the control unit resumes the printing by the image forming apparatus.

12. An image forming method for an image forming apparatus including an image forming unit configured to form a toner image on a first surface of a medium, a heating member configured to heat the first surface of the medium, a pressurizing member configured to be pressed in contact with the heating member via the medium to heat a second surface of the medium, and a supply unit configured to supply a used medium to the image forming unit, the method comprising:
when the used medium is supplied from the supply unit,
controlling a fixing setting temperature of the pressurizing member to a temperature equal to or lower than a temperature for fixing on the unused medium; and
controlling a fixing temperature of the heating member to a temperature equal to or higher than a temperature for fixing on the unused medium.

13. The method of claim 12, wherein the fixing setting temperature of the pressurizing member is controlled to a temperature between a second threshold temperature that is equal to or lower than the temperature for fixing on the unused medium and a first threshold temperature that is lower than the second threshold temperature.

14. The method of claim 13, wherein a fixing temperature expressed by the temperature of the pressurizing member and the temperature of the heating member controlled by the control unit is within a fixing-enabled zone.

15. The method of claim 14, wherein the second threshold temperature is lower than a temperature at which a toner recorded on the second surface of the medium remelts.

16. The method of claim 15, wherein the image forming apparatus further comprises a first temperature sensor configured to detect the temperature of the pressurizing member,
wherein when the first temperature sensor detects that the temperature of the pressurizing member is equal to or higher than the second threshold temperature, power for heating of the pressurizing member is turned off.

17. The method of claim 16, wherein when the power for heating of the pressurizing member is turned off,
after power equivalent to or less than the amount of power that is turned off is added to an upper limit value of power for heating of the heating member, a temperature target value is increased in temperature control of the heating member.

18. The method of claim 17, wherein when the first temperature sensor detects that the temperature of the pressurizing member is equal to or lower than the first threshold temperature,
after the temperature target value of the heating member is restored to a value before the increase, the upper limit value of power for heating of the heating member is restored to a value before the addition, and
the power for heating of the pressurizing member is turned on.

19. The method of claim 18, wherein when the fixing temperature expressed by the temperature of the pressurizing member and the temperature of the heating member that are controlled exits the fixing-enabled zone, printing by the image forming apparatus is stopped while the temperature control is continued, and
when the fixing temperature shifts back into the fixing-enabled zone, the printing by the image forming apparatus is resumed.

20. The method of claim 19, wherein a heating unit which heats the heating member is an induction heater.

21. The method of claim 17, wherein when the first temperature sensor detects that the temperature of the pressurizing member is equal to or lower than the first threshold temperature,
after the upper limit value of power for heating of the heating member is restored to a value before the addition, the power for heating of the pressurizing member is turned on.

22. The method of claim 21, wherein when the fixing temperature expressed by the temperature of the pressurizing member and the temperature of the heating member that are controlled exits the fixing-enabled zone, printing by the image forming apparatus is stopped while the temperature control is continued, and
when the fixing temperature shifts back into the fixing-enabled zone, the printing by the image forming apparatus is resumed.
